(19) United States
(12) Patent Application Publication
(10) Pub. No.: US 2015/0295414 A1
(43) Pub. Date: Oct. 15, 2015

(54) METHOD FOR DISTRIBUTING A POWER AMONG A PLURALITY OF CONSUMER UNITS OF A RAIL VEHICLE

(71) Applicant: SIEMENS AKTIENGESELLSCHAFT, München (DE)

(72) Inventors: Stefan Di Bonaventura, Buechenbach (DE); Gerhard Steinhauer, Willich (DE)

(21) Appl. No.: 14/434,173

(22) PCT Filed: Oct. 1, 2013
(86) PCT No.: PCT/EP2013/070421

§ 371 Date: Apr. 8, 2015

(30) Foreign Application Priority Data
Oct. 8, 2012 (DE) 10 2012 019 636.9
Oct. 19, 2012 (DE) 10 2012 219 077.5

(51) Int. Cl. H02J 4/00; B60L 1/00; B61L 15/00

(52) U.S. Cl. CPC H02J 4/00; B61L 15/0018; B60L 1/003

(57) ABSTRACT

Electric power is distributed over a plurality of load units of a rail vehicle. In order to reduce the adaptation complexity upon changing the configuration of the rail vehicle, the rail vehicle is divided into a group of sections. A group of distribution priorities is defined, and a distribution priority is allocated to each load unit, each of which is identified by a section variable and a priority variable. Power to be granted is ascertained in a granting process depending on power requirement, available power, and allocated distribution priority. Granting processes for a given priority variable value and for the section variable values assigned to at least one sub-group of the group of sections are carried out in a section cycle. A priority cycle is carried out in which a section cycle is carried out for the priority variable values assigned to a sub-group of the group of distribution priorities.

The invention relates to a method for distributing an electrical power among a plurality of consumer units of a rail vehicle.

In known rail vehicles, an electrical power is distributed over a power supply line which is laid along the vehicle, also referred to as “train busbar” by those skilled in the art, to which electrical consumers are connected. This power supply line is fed electrical power by a plurality of power supply devices. The power supply devices draw the electrical energy from an energy source, which is formed by a railroad line or a generator of the rail vehicle, and are conventionally used for generating an electrical power from this available energy by generating an electrical signal with properties matched to the power demand. Generally, the power supply devices are formed by converters.

In the event of a failure of a power supply device, the required consumer power can exceed the available supply power. In this case, control of the consumers is necessary in order that the feed-in points at which the power supply line is connected to the remaining power supply devices do not become overloaded.

For a fixed configuration, i.e. a fixed assembly of a rail vehicle and a fixed number of consumers, already failure scenarios have been proposed in which, corresponding to the power available at that time, certain consumers are disconnected in order that the power demand does not overload the power supply line.

This control is dependent on the respective configuration and the possible failure scenarios, as a result of which corresponding adaptation complexity in the case of a change of configuration results. This complexity is associated in particular with the following configuration changes: changed number of railcars, a change to the type of railcar, changed number of consumers, a replacement of consumers with consumers with different power values, a change to the way in which the power supply line is split up, etc.

The invention is based on the object of providing a method for distributing an electrical power among a plurality of consumer units of a rail vehicle, in which the adaptation complexity in the case of a change to the configuration of the rail vehicle can be reduced.

For this purpose, it is proposed that
the rail vehicle is divided into a group of sections, wherein at least one power supply unit is provided for the group, and the sections are connected in pairs to one another by a section transition, via which a power transmission can be produced,
a group of distribution priorities is defined, and in each case one distribution priority is allocated to the consumer units,
the consumer units are identified as being assigned by means of a section characteristic quantity as a section and as being assigned to a distribution priority by means of a priority characteristic quantity,
in a granting process, a power to be granted for a consumer unit is determined depending on a power demand, an available power and the allocated distribution priority,
in a section run, granting processes are implemented for a given value of the priority characteristic quantity and the values of the section characteristic quantity which are assigned at least to a subgroup of the group of sections, and a priority run, in which a section run for the values of the priority characteristic quantity which are assigned at least to a subgroup of the group of distribution priorities, is implemented.

This can be achieved by virtue of the fact that the power distribution process is based on an advantageous representation of the entire arrangement of the consumer units in the rail vehicle. In the event of a change to the configuration of the rail vehicle, the adaptation complexity for the power distribution process can advantageously be restricted to the adaptation of this representation, wherein other changes to process steps which result from this representation can largely be avoided. With the preferred use of two attributes for this depiction in the form of the assignment of a consumer unit to a section of the rail vehicle and an allocated distribution priority, a simple representation can be provided in matrix form. A change to the configuration of the rail vehicle in particular as regards the number of sections and the number of consumer units of different types is advantageously represented by an extension or division of the matrix, wherein the change in configuration can be based on an operationally determined change or a fault-related change. In addition, improved utilization of existing power reserves can be achieved.

The consumer units are in particular connected to a power supply line laid across the vehicle, also referred to as a “train busbar”, into which the at least one power supply unit feeds power. The power transmission from the power supply unit to the consumer units, possibly via the section transitions, accordingly expediently takes place via the train busbar.

A “consumer unit” is intended in particular to mean an electrical consumer or a set of electrical consumers which are designed so as to be substantially identical to one another in terms of their operation.

“Granting” of a power is intended in particular to mean that the respective consumer unit is allocated a power characteristic quantity. This power characteristic quantity can be a power or a characteristic quantity which presets a power. For example, a power characteristic quantity can be allocated in the form of an electrical current. The power granted in a granting operation can correspond to the power demand, which is preferably communicated by the consumer unit, or less than this. In particular, the granted power can correspond to a zero power which corresponds to a switch-off command for an operated consumer unit and to a start disable for a consumer unit which is not yet in operation.

The granted power is dependent on the respective distribution priority and on a power available. This takes into consideration in particular the total power which can be provided by the at least one power supply unit and the sum of the powers granted in previous granting processes. In contrast to conventional methods for power distribution, in which a power matching takes place on the basis of predetermined application scenarios, with the proposed method, consumer units are in particular only restricted when the total power demand of the consumer units operated simultaneously exceeds the total power supply.

Preferably, the priority run is implemented a plurality of times during operation of the consumer units. As a result, regular matching of the power distribution to a variable power demand can take place. When consumer units do not constantly have a power demand or the power demand of a consumer unit is not constant, with repeated, in particular regular implementation of the priority run it is possible for a released power to be redistributed quickly and efficiently.

In a further variant embodiment of the invention, it is proposed that in the granting process, the determination of the power to be granted is dependent on a characteristic quantity for a transition power at at least one section transition. As a result, during the power distribution the loadability of the train busbar can advantageously be taken into consideration. Hereby, savings can be achieved in respect of the design of the train busbar since the maximum loading of the train busbar can advantageously be regulated with the local granting to the consumer units. By virtue of this regulation, in addition the cases of a disconnection of the train busbar, for example as a result of tripping of fuses, can also largely be avoided, wherein the availability of the rail vehicle can be increased. The characteristic quantity can be determined on the basis of the granted powers and/or it can be detected by means of sensors, such as current sensors, for example.

The subdivision of the rail vehicle into different sections can take place in a variety of ways, wherein the sections can be delimited by logical or physical separations. If the rail vehicle has a plurality of railcars, a section can be formed by a railcar part, a set of a plurality of railcar parts, a plurality of railcars, etc. An advantageous representation as regards the assembly of the rail vehicle can be achieved, however, if the sections each correspond to a different railcar.

Preferably, in the priority run, successive section runs are implemented with decreasing distribution priority. As a result, the power demand of consumer units of higher distribution priorities can be taken into consideration easily and systematically. A zero power is preset to consumer units with a low distribution priority in particular when, owing to previous power grantings to consumer units with relatively high distribution priorities, there is too little or no power available.

In the case of a priority run, expediently different pairs of values of the priority characteristic quantity and the section characteristic quantity are sampled and preferably a granting process is implemented for each of these pairs.

In accordance with a distribution mode, in the priority run, the granting operations of the section runs are implemented for the values of the section characteristic quantity which are assigned to the group of sections. As a result, a power distribution can be performed for all sections of the rail vehicle. This mode is particularly suitable for normal operation of the rail vehicle with a fault-free power supply and an interruption-free power transmission at the section transitions.

In this distribution mode, preferably in the priority run, the section runs are implemented for the values of the priority characteristic quantity which are assigned to the group of distribution priorities, as a result of which systematic sampling of all pairs of the priority characteristic quantity and the section characteristic quantity and a granting process for all consumer units take place.

In accordance with a further distribution mode, the rail vehicle is divided into at least two subgroups of coupled sections, and a priority run is implemented for at least one of the subgroups. As a result, advantageous matching of the power distribution to a fault-based and/or operation-based division of the rail vehicle can be achieved.

The division of the rail vehicle can be based on a physical or logical separation. In accordance with a first application case, a disconnection means prevents power transmission between the subgroups, wherein a different power supply unit is provided for each of the subgroups, and a priority run is implemented for each subgroup. As a result, the rail vehicle can be separated into two autonomous supply regions in respect of the power supply, which two autonomous supply regions are each supplied at least by a different power supply unit. The separation means can be in particular in the form of a switching element, which is arranged at a section transition.

In a further application case, the division of the rail vehicle can be based on a faulty power supply. In this application case, it is proposed that characteristic quantities for the transition power across section transitions are detected, a condition for a critical transition power is preset, and, in the event of the onset of the condition at a section transition, the following steps are implemented:
logical division of the rail vehicle into two subgroups of sections on both sides of the section transition,
detection of a characteristic quantity, which is dependent on the power allocated in each case to the subgroups,
in the subgroup which is allocated the greatest power, implementation of a priority run in which successive section runs are implemented with increasing distribution priority and power is drawn from the corresponding consumer units.

In this case, a priority run advantageously takes place for the values of the section characteristic quantity which correspond to the sections of the subgroup of sections in which the greatest power is drawn. In this subgroup, a run through the consumer units can take place, beginning with the lowest distribution priorities, in which the distribution units are in particular granted a zero power. After each granting process or power withdrawal, preferably at least the characteristic quantity for the transition power at the section transition at which the condition has occurred is detected, wherein the priority run is expediently stopped if the transmission power is reduced below the critical value. The proposed method is in particular suitable for a rail vehicle in which the group of sections is supplied by a plurality of power supply units. In the event of failure of a power supply unit or of a reduction in the power provided by said power supply unit, increased power transmissions can occur at section transitions. By virtue of the proposed method, permanent local overloading of the train busbar at a section transition can advantageously be avoided.

The invention also relates to a rail vehicle comprising a group of sections, comprising at least one power supply unit, which is intended for supplying power to the group, wherein the sections are connected to one another in pairs by a section transition, via which a power transmission is producible, comprising consumer units, which are each assigned to one of the sections, and comprising a control unit, which is connected to the power supply unit and the consumer units and is intended for implementing the method in accordance with one of the above-described embodiments. In respect of the advantageous effects of this combination of features, reference is made to the above statements regarding the method in order to avoid unnecessary repetition.

Exemplary embodiments of the invention will be explained with reference to the drawings, in which:

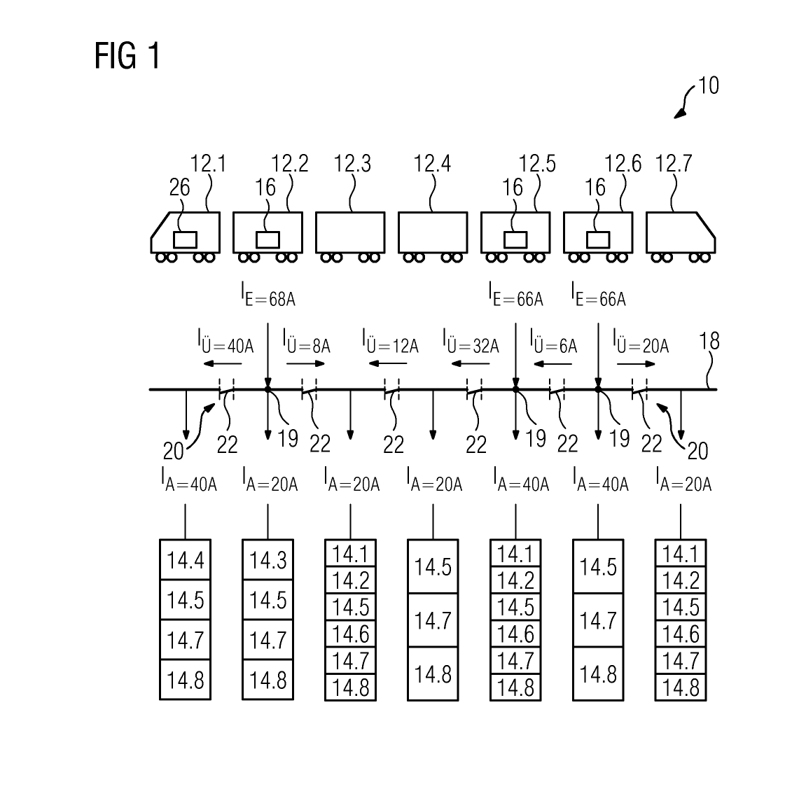

FIG. 1 shows a rail vehicle comprising consumer units, which are supplied by means of a train busbar,

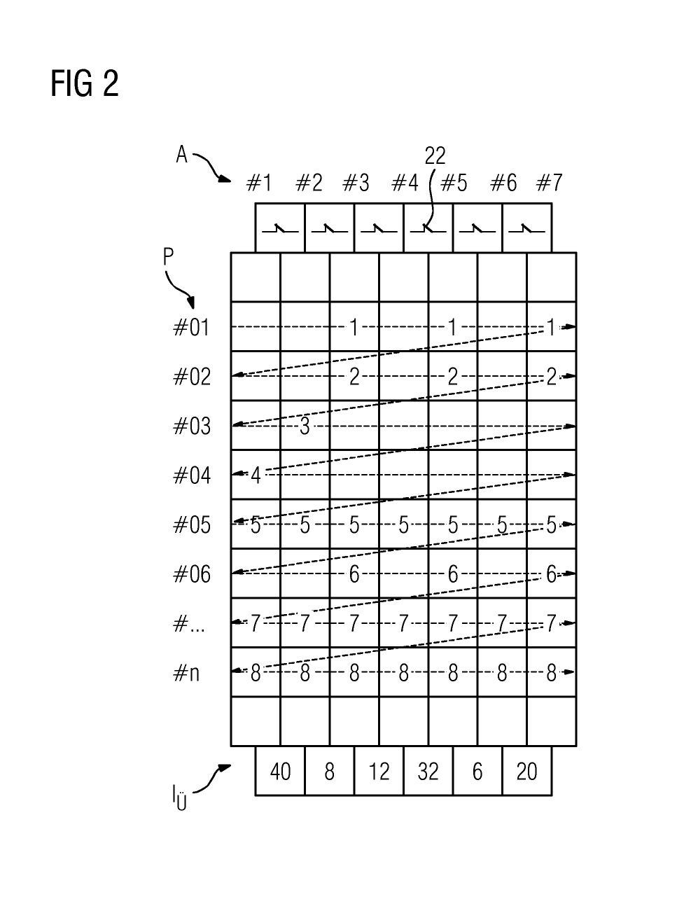

FIG. 2 shows a representation provided for the power distribution of the consumer units in matrix form in accordance with an association with a section of the rail vehicle and a distribution priority,

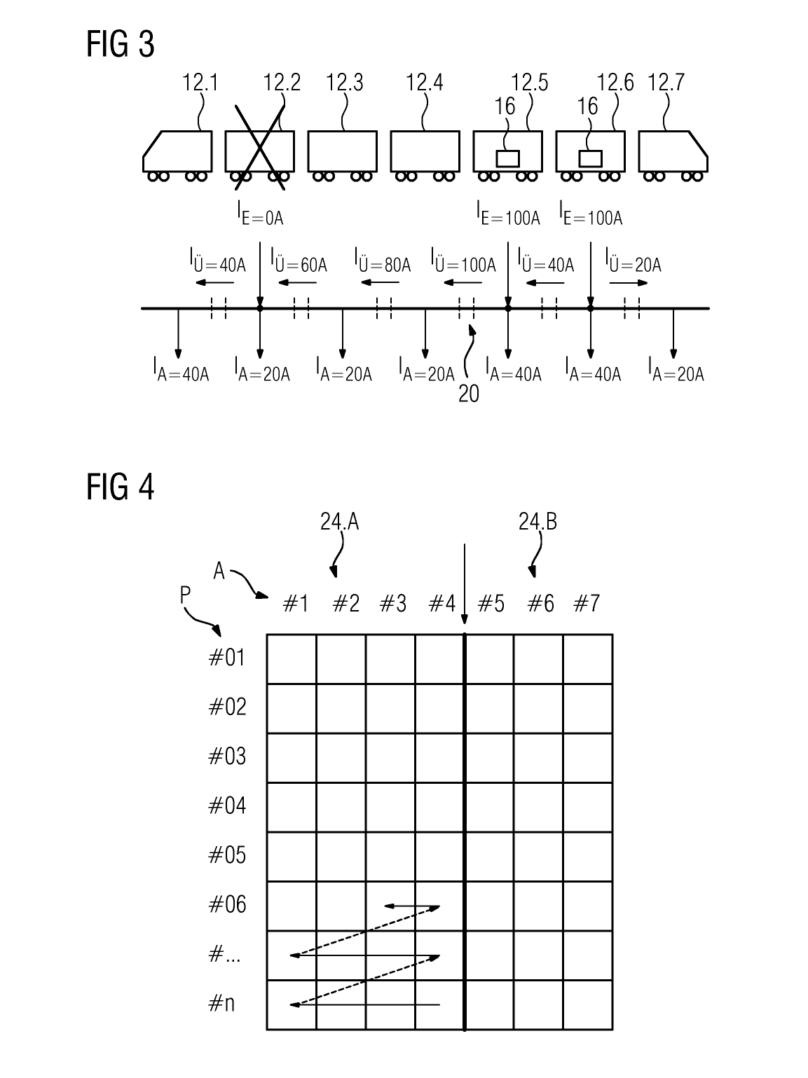

FIG. 3 shows the rail vehicle shown in FIG. 1 in the event of failure of a power supply unit,

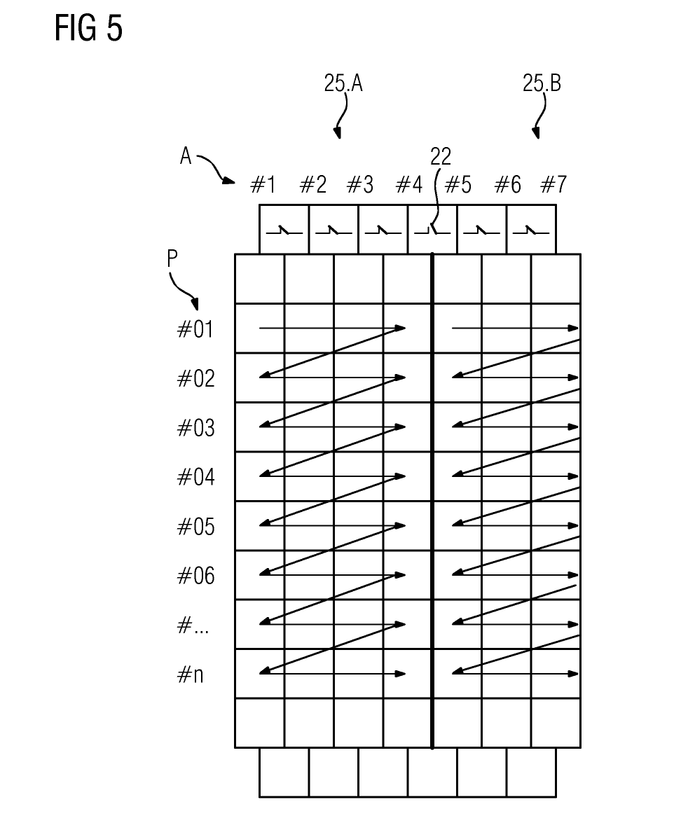

FIG. 4 shows the representation shown in FIG. 2 in the application case of FIG. 3, and

FIG. 5 shows the representation shown in FIG. 2 with a disconnected train busbar.

FIG. 1 shows a rail vehicle 10 in a schematic side view. Said rail vehicle has a multiplicity of railcars coupled to one another. The rail vehicle 10 in the exemplary embodiment under consideration is in the form of a multiple unit for the transport of passengers, in which drive elements are arranged in at least one of the railcars. Alternatively, the rail vehicle 10 is in the form of a loco-hauled train.

Each railcar is referred to as section 12.1 to 12.7 of the rail vehicle 10, wherein a section 12 is formed by a railcar. Further divisions of the rail vehicle 10 in a group of sections 12 are conceivable, in which a section is formed by a plurality of railcars, by half a railcar or by a pair of railcar halves of different railcars.

The rail vehicle 10 has electrical equipment provided with a plurality of electrical consumer units 14.1 to 14.8, which are distributed in the rail vehicle 10. The consumer units 14 are illustrated in the lower part of FIG. 1 beneath the respective section 12 in which they are arranged, for reasons of clarity. The consumer units 14.1, 14.2, etc., differ from one another in particular in terms of their operation and their type. In order to supply electrical power to the consumer units 14, the rail vehicle 10 is provided with power supply units 16, which are likewise distributed in the rail vehicle 10. The power supply units 16 in the embodiment under consideration are each arranged in a different section 12 or railcar. In the abovementioned variant embodiment of the rail vehicle 10 as a loco-hauled train, the at least one power supply unit 16 required for the supply to the rail vehicle 10 can be arranged in the locomotive.

In the embodiment under consideration, the consumer units 14 are so-called auxiliaries of the rail vehicle 10, which are in particular selected from the following group of electrical consumers: air compressor (14.3), battery charger (14.4), air conditioning system in heating, ventilation or cooling mode (14.7, 14.5 and 14.8, respectively), transformer and/or power converter fan having a low or high stage (14.2 and 14.6, respectively) or transformer and/or power converter fan pump (14.1).

The power supply units 16 are in particular in the form of auxiliaries converters, which generate a three-phase current, which is distributed over a train busbar 18 over the entire rail vehicle 10, as is illustrated schematically in the central part in FIG. 1. By virtue of the train busbar 18, a power supply line over the entire vehicle is provided in that the sections 12 are connected to one another in pairs by a section transition 20, via which a power transmission between two adjacent sections 12 can be produced. The power transmission between two coupled sections 12 can be interrupted by a disconnection means 22, for example in the form of a contactor. The power supply units 16 are connected to the train busbar 18 in order to feed electrical power thereto at different power feed-in points 19, which are arranged distributed in the rail vehicle 10 or along the train busbar 18. A characteristic quantity for the power fed into the train busbar 18 from the power supply units 16 represents a feed-in current I_{E} at the feed-in points 19. In addition, a further characteristic quantity I_{Ü} for a transition power, which is transmitted between the sections 12 at the section transitions 20, is illustrated. The characteristic quantity I_{Ü} corresponds to a transition current. Furthermore, a characteristic quantity I_{A} for the power drawn from the consumer units 14 of a specific section 12 is shown. This characteristic quantity I_{A} likewise corresponds to an electrical current.

Each consumer unit 14 can be characterized by different attributes. A first attribute for a consumer unit 14 is formed by the assignment, in particular the association, of this consumer unit 14 to a section 12. For various types of consumers, a second attribute is defined, which is dependent on the priority with which power is allocated to the consumers of the respective type, and corresponds to a distribution priority. A group of distribution priorities in accordance with the various consumer types is defined, wherein in each case one distribution priority is allocated to the consumer units 14.

Each consumer unit 14 can accordingly be assigned a pair of characteristic quantities in relation to this attribute, wherein a representation of the arrangement of consumer units 14 in the form of a matrix is possible.

This representation in the form of a matrix is shown in FIG. 2. As illustrated in this figure, the consumer units 14 of the rail vehicle 10 are identified as being assigned to a section 12, by means of a section characteristic quantity A, and as being allocated to a specific distribution priority, by means of a priority characteristic quantity P. In this matrix, a row corresponds to a value of the priority characteristic quantity P and a column corresponds to a value of the section characteristic quantity A. A matrix element accordingly corresponds to a specific consumer unit 14 or is an empty element. The values of the priority characteristic quantity P are numbers, wherein the distribution priority decreases as the values of the priority characteristic quantity P increase. The value “1” therefore corresponds to the greatest distribution priority and, in the case of a group of distribution priorities with n priority classes, the value “n” corresponds to the lowest priority. The values of the section characteristic quantity A are numbers, which each correspond to the position of the section 12 in the rail vehicle 10.

Above the matrix, the respective status of the disconnection means 22 at the section transitions 20 is illustrated schematically. In the example under consideration, all of the disconnection means 22 are in a conducting position, so that the train busbar 18 is not interrupted across the vehicle.

The distribution of electrical power among the set of consumer units 12 of the rail vehicle 10 is described below.

In a first step, a power available to the entire group of sections 12 is determined. For example, this power can correspond to the sum of the powers made available by the power supply units 16.

The power distribution corresponds to a sequence of granting processes, which are each based on a different consumer unit 14. In this case, granting processes are performed for different pairs of the section characteristic quantity A and priority characteristic quantity P or for different matrix elements. In the granting processes, in each case at least one power which is to be granted to the respective consumer unit 14 is determined, to be precise on the basis of a power demand communicated by the consumer unit 14, an available power and the allocated distribution priority. The available power which is the basis for a granting process, can result from the total power, from which the sum of the powers granted in previous granting processes is subtracted. After termination of a granting process, the power still available for the further granting processes is updated. The power to be granted to the respective consumer unit 14, as is determined in the granting process, can correspond to the power demand communicated by the consumer unit 14 or a lower power, such as in particular a zero power, depending on the abovementioned factors.

For the power granting of the consumer units 14, the consumer units 14 are handled beginning with the highest distribution priority. A priority run through the matrix shown in FIG. 2 is performed. Said matrix is run through row by row. This is represented by means of dashed arrows. In this case successive row runs in accordance with decreasing distribution priorities or increasing values of the priority characteristic quantity P are implemented. A row run in which the columns of the matrix are run through for a given value of the priority characteristic quantity P corresponds to a section run, in which a granting process is implemented successively for all of the values of the section characteristic quantity A, which correspond to the sections 12 of the group of sections 12, for this given value of the priority characteristic quantity P. If, for a given pair of section characteristic quantity A and priority characteristic quantity P, there is no consumer unit 14 with these attributes, the granting process merely corresponds to the granting of a zero power or to mere incrementation of the section characteristic quantity A and possibly the priority characteristic quantity P.

The priority run can be interrupted when further power grantings are not possible owing to the remaining available power. In this case, the priority run takes place for a subgroup of distribution priorities.

However, it is advantageous that the priority sequence is continued even when the available power does not enable any further granting of a positive power in the case of granting processes. This case can occur, for example, when one or more consumer units 14 with a high distribution priority communicate a high power demand, a corresponding power is granted to these consumer units 14 and the available power after these power grantings is insufficient for further granting of a positive power for consumer units 14 with lower distribution priorities. In this case, a “zero power” is granted to these consumer units 14 with lower distribution priorities, which corresponds to a switch-off command for consumer units 14 which are already in operation or a lockout for consumer units 14 which are in the switched-off state.

If a plurality of consumer units 14 communicate a high runup power demand, in repeated priority runs in each case only one consumer unit 14 with a high runup power can be enabled for switching or granted a positive power, depending on the respective runup power demand and an available power. If a plurality of consumer units 14 with the same distribution priority communicate a runup power demand, in each case one consumer unit 14 with a high runup power is enabled for switching in this case, per priority run.

With repeated priority sequences, if required the total available power can advantageously be redistributed among the consumer units 14 in accordance with their respective distribution priority.

A granting process for a consumer unit 14 takes place as described above on the basis of a power demand communicated by the consumer unit 14, a power available for granting and the distribution priority. In addition, the determination of the power to be granted can take place on the basis of the characteristic quantity I_{Ü} for a transition power at at least one section transition 20 (see also FIG. 1). On the basis of the powers granted for the consumer units 14, the arrangement of the feed-in points 19 of the power supply units 16 and the power made available thereby, the characteristic quantity I for this transition power can be determined at the section transitions 20 at which the respective disconnection means 22 permits transmission of power between adjacent sections 12. In a granting process of a consumer unit 14, a maximum transition power which is not to be exceeded at the section transitions 20 represents a further boundary condition. Owing to the power granting to a consumer unit 14, no section transition 20 can be overloaded. The characteristic quantities I_{Ü} are in particular updated after termination of each granting process.

In the example under consideration with reference to FIGS. 1 and 2, all of the disconnection means 22 are located in a conducting position, as a result of which the train busbar 18 is not interrupted over the vehicle. In the case of a priority run, a granting process takes place for the values of the section characteristic quantity A, which are assigned to the entire group of sections 12.1 to 12.7. Since a section run takes place for the values of the priority characteristic quantity P which are assigned to the entire group of distribution priorities, a granting process for each consumer unit 14 of the matrix shown is implemented in the priority run.

In this example, it has also been assumed that all of the power supply units 16 are fully functional.

FIG. 3 shows the rail vehicle 10 shown in FIG. 1 in the event of a failure of one of the power supply units 16, in particular the power supply unit 16 arranged in the section 12.2. Owing to the failure, the maximum permissible transition power at at least one of the section transitions 20 is exceeded. For example, it is assumed that an increased current with the value I_{Ü}=100 A is produced at the section transition 20 between the sections 12.4 and 12.5.

The detection of the maximum permissible transition power being exceeded initiates the following steps. First the mathematical sign of the transition current or the characteristic quantity I_{Ü} at this section transition 20 is detected. As a result, it is possible to determine, based on the longitudinal direction of the rail vehicle 10, on which side of the section transition 20 there is the greatest power withdrawal and a reduction of powers needs to be implemented in order that the characteristic quantity I_{Ü} is reduced to a permissible value.

In this case, the rail vehicle 10 is virtually divided into two subgroups 24.A and 24.B of sections 12.1 to 12.4, on the one hand, and 12.5 to 12.7, on the other hand, wherein the subgroups 24.A and 24.B are arranged on both sides of the section transition 20 with an exceeded transition current. This is illustrated in FIG. 4, which corresponds to the representation in matrix form in FIG. 2.

A power withdrawal takes place in subgroup 24.A, in which there is the greatest power withdrawal in accordance with the detected mathematical sign of the characteristic quantity I_{Ü}. For this purpose, a priority run is only implemented in subgroup 24.A, wherein successive section sequences are implemented as the distribution priority increases. This is represented schematically by means of arrows. In these section sequences, only the values of the section characteristic quantity A which are assigned to the subgroup 24.A of sections 12.1 to 12.4 are sampled. Accordingly, there is no granting process for the sections 12.5 to 12.7 of the second subgroup 24.B. The priority run begins with the lowest distribution priority or the highest priority characteristic quantity P. In the granting processes, in principle a zero power is granted, which corresponds to the respective consumer units 14 being switched off or locked out. The characteristic quantities I_{Ü} are recalculated or redetected by means of sensors after each granting process. The priority run in the subgroup 24.A is interrupted when the maximum permissible transition power at the section transitions 20 is undershot.

In the example explained with reference to FIGS. 3 and 4, a logical division of the entire group of sections 12.1 to 12.7 into two subgroups 24.A and 24.B took place, which corresponds to a logical division and is canceled after production of permissible transition powers at the section transitions 20.

FIG. 5 shows a further application case in which a division of the group of sections 12.1 to 12.7 is performed physically. This division is performed by a disconnection means 22, which interrupts the train busbar 18 at a point, as a result of which a split train busbar 18 is produced.

For example, the train busbar 18 is interrupted at the section transition 20 between the sections 12.4 and 12.5, as a result of which two separate subgroups 25.A and 25.B of sections 12.1 to 12.4 and 12.5 to 12.7, respectively, are formed. The physical separation is intended to be performed in such a way that a power feed can take place by means of at least one power supply unit 16 for each subgroup 25.A and 25.B.

With respect to the power distribution, the procedure is as explained above for the entire group of sections 12.1 to 12.7 in each subgroup 25.A, 25.B. Each subgroup is considered as an autonomous unit in respect of the power supply, in which in each case priority runs are implemented. In the case of a priority run in a subgroup, the section runs are performed only for the values of the section characteristic quantity A which are assigned to the respective subgroup.

The rail vehicle 10 has, in at least one of the sections 12 or one of the railcars, a control unit 26, which is operatively connected to the power supply units 16 and the consumer units 14 and is provided for implementing the distribution of the electrical power in accordance with the abovementioned method. In addition, sensor units can be arranged at the section transitions, which sensor units are used for the detection of the characteristic quantity I_{Ü}. If this characteristic quantity is taken into consideration in the granting processes, the control unit 26 is likewise operatively connected to the sensor units.

1-11. (canceled)

12. A method of distributing electrical power among a plurality of consumer units of a rail vehicle, the method comprising:
dividing the rail vehicle into a group of sections, wherein at least one power supply unit is provided for the group and the sections are connected in pairs to one another by a section transition for transmitting power between the sections;
defining a group of distribution priorities and allocating a respective distribution priority to each consumer units;
identifying the consumer units with a section characteristic quantity as being assigned to a given section and with a priority characteristic quantity as being assigned a distribution priority;
in a granting process, determining a power to be granted for a consumer unit depending on a power demand, an available power, and the allocated distribution priority;
in a section run, implementing granting processes for a given value of the priority characteristic quantity and the values of the section characteristic quantity which are assigned at least to a subgroup of the group of sections; and
in a priority run, implementing a section run for the values of the priority characteristic quantity which are assigned at least to a subgroup of the group of distribution priorities; and
distributing the electrical power to the consumer units of the rail vehicle accordingly.

13. The method according to claim 12, which comprises implementing the priority run a plurality of times during operation of the consumer units.

14. The method according to claim 12, wherein the granting process comprises determining the power to be granted in dependence on a characteristic quantity for a transition power at at least one section transition.

15. The method according to claim 12, wherein the rail vehicle has a plurality of railcars and wherein each section corresponds to a respective railcar.

16. The method according to claim 12, which comprises, in the priority run, implementing successive section runs with decreasing distribution priority.

17. The method according to claim 12, which comprises, in the priority run, implementing the granting operations of the section runs for the values of the section characteristic quantity which are assigned to the group of sections.

18. The method according to claim 17, which comprises, in the priority run, implementing the section runs for the values of the priority characteristic quantity which are assigned to the group of distribution priorities.

19. The method according to claim 12, which comprises dividing the rail vehicle into at least two subgroups of mutually coupled sections, and implementing a priority run for at least one of the subgroups.

20. The method according to claim 19, wherein a disconnection device is configured to prevent a power transmission between the subgroups, a different power supply unit is provided for each of the subgroups, and the method comprises implementing a priority run for each subgroup.

21. The method according to claim 19, which comprises:
detecting characteristic quantities for a transition power across section transitions, wherein a condition for a critical transition power is preset, and, in the event of an onset of the condition at a section transition, performing the following steps:
logically dividing the rail vehicle into two subgroups of sections on both sides of the section transition;
detecting a characteristic quantity, which is dependent on the power allocated in each case to the subgroups;
in the subgroup which is allocated a greatest power, implementing a priority run in which successive section runs are implemented with increasing distribution priority; and
withdrawing power from the corresponding consumer units.

22. A rail vehicle, comprising:
a group of sections having at least one power supply unit configured for supplying power to the group;
said sections being connected to one another in pairs by way a section transition, via which a power transmission is producible;
consumer units each assigned to a respective one of said sections; and
a control unit connected to said power supply unit and to said consumer units and configured for implementing the method according to claim 12.
